(19) United States
(12) Patent Application Publication
(10) Pub. No.: US 2026/0233159 A1
(43) Pub. Date: Aug. 13, 2026

(54) WASTE HANDLING FOR RENEWABLE TRANSPORTATION FUEL PROCESSES

(71) Applicant: Honeywell International Inc., Charlotte, NC (US)

(72) Inventors: Neeraj Jatashankar Tiwari, Gurgaon (IN); Alec A. Sheir, Tulsa, OK (US); William J. Whyman, Collinsville, OK (US); Kevin M. O'Neil, Lincolnshire, IL (US)

(21) Appl. No.: 19/429,387

(22) Filed: Dec. 22, 2025

(30) Foreign Application Priority Data
Feb. 10, 2025 (IN) 202511011075

(51) Int. Cl. B01D 53/75; B01D 19/00; B01D 53/02; B01D 53/14; B01D 53/56; B01D 53/76; B01D 53/86

(52) U.S. Cl. CPC B01D 53/75; B01D 19/0068; B01D 53/02; B01D 53/1468; B01D 53/56; B01D 53/76; B01D 53/8625; B01D 2251/2062; B01D 2251/2067; B01D 2252/204; B01D 2253/1122; B01D 2257/304; B01D 2257/404; B01D 2258/0283

(57) ABSTRACT

Processes for treating acid gas streams in a process for producing renewable transportation fuel are described. The H₂S in the acid gas stream may be removed using one or more of adsorption processes, amine processes, scrubbing processes, and/or a neutralization processes. The acid gas stream with a reduced level of sulfur is thermally oxidized, and NOx is removed from the thermally oxidized stream.

### CROSS-REFERENCES TO RELATED APPLICATIONS

This application claims the benefit of Indian Provisional Patent Applicant No. 20251101075 filed on Feb. 10, 2025, the entire disclosure of which is incorporated herein by way of reference.

### BACKGROUND

As the demand for diesel and jet boiling range fuel increases worldwide, there is increasing interest in feedstock sources other than petroleum crude oil. One such source is what has been termed “renewable” and “biological” feedstocks. These renewable biological feedstocks include, but are not limited to, plant oils such as corn, jatropha, camelina, rapeseed, canola, and soybean oil, algal oils, and animal fats such as tallow and fish oils. The common feature of these sources is that they are composed of glycerides and Free Fatty Acids (FFAs). Both of these classes of compounds contain normal aliphatic carbon chains having from about 8 to about 24 carbon atoms. The aliphatic carbon chains in the glycerides or FFAs can be fully saturated or mono, di- or poly-unsaturated. The sidechains of the glycerides and the FFAs in biological oils and fats can be converted into diesel or jet fuel using many different processes, such as hydrodeoxygenation and hydroisomerization processes.

Fuel processed from renewable biological sources is desirable for a variety of reasons. Foremost, the use of renewable biological-sourced fuels reduces the demand for the extraction and use of fossil fuels. This is especially true for transportation fuels such as diesel and jet fuel. In addition to the ecological benefits of using biological-sourced fuel, there exists a market demand for such fuel. For fuel purchasers, the use of biological-sourced fuel can be promoted in public relations. Also, certain governmental policies may require or reward use of biological-sourced fuels.

Current renewable transportation fuel production processes produce a variety of effluent streams that must be treated and disposed of. Advancements in the process for making renewable transportation fuel have changed the nature of the waste streams requiring additional treatment.

Therefore, there is a need for new processes for treating effluent streams, particularly those related to acid gas and sour water. It would also be desirable to reduce capital and operating costs, as well as to reduce the complexity of the process and the amount of equipment needed.

### BRIEF DESCRIPTION OF THE DRAWINGS

FIG. 1 is an illustration of one embodiment of the acid gas treatment process according to the present invention.

FIG. 2 is an illustration of one embodiment of the thermal oxidation section and a NOx treatment section according to the present invention.

FIG. 3 is an illustration of another embodiment of the thermal oxidation section and an NOx treatment section according to the present invention.

FIG. 4 is an illustration of another embodiment of the thermal oxidation section and a NOx treatment section according to the present invention.

FIG. 5 is an illustration of another embodiment of the acid gas treatment process according to the present invention.

### DETAILED DESCRIPTION

Novel processes have been developed to take advantage of the changed nature of the waste streams in renewable transportation fuel processes. The new processes treat the waste streams while reducing the capital and operating costs compared to some existing waste treatment flow schemes.

Previously, the waste streams coming from processes for making renewable transportation fuel were too extreme to use the new treatment flow schemes. However, advancements in the renewable transportation processes have changed the waste streams (e.g., lower flow rate and/or lower sulfur content), making the new flow scheme feasible and providing an economic advantage over existing waste treatment processes.

Renewable transportation fuel production processes produce one or more sour water streams. The sour water streams include a cold separator sour water stream from a cold separator in the cold separation and fractionation section, a de-butanizer receiver sour water stream from a de-butanizer in the cold separation and fractionation section, and a stripper receiver sour water stream from a stripper receiver in the cold separation and fractionation section. The sour water streams are sent to a sour water stripper unit The remainder may be sent to a waste water treatment plant. Acid gas from the sour water stripper is treated using a variety of treatment processes. Many existing treatment schemes using amine treatment have high capital costs.

The new process schemes use sulfur removing processes to replace amine treatment to purify off-gases for product recovery. In some embodiments, the processes may include a sour water stripper and sulfur removing processes paired with thermal oxidation.

Sour water streams from the renewable transportation fuel processes may be separated in a sour water stripper into a stripped sour water stream and an acid gas stream. The stripped sour water stream may be treated in an existing waste water treatment facility.

The acid gas stream typically contains NH₃, CO₂, H₂S, water, and hydrogen.

The H₂S in the acid gas stream may be removed using one or more of adsorption processes, amine processes, scrubbing processes, and/or a neutralization processes. One adsorbent process involves the use of an iron sponge type adsorbent. Following removal of the H₂S, the resulting second acid gas stream has a lower level of H₂S than the incoming acid gas stream.

The second acid gas stream is thermally oxidized in a thermal oxidizing section. The thermal oxidizing section comprises a thermal oxidizer which incinerates the second acid gas stream. The hydrocarbons are converted to H₂O and CO₂., and the nitrogen from the nitrogen bound molecules (e.g., NH₃) present in the feed are converted to nitrogen (N₂) and NOx, including but not limited to NO, NO₂. Any suitable thermal oxidizing section could be used, including, but not limited to, an adiabatic thermal oxidizer chamber. The thermal oxidizing section can be forced draft, induced draft, or a combination of both.

A NOx treatment section may be present in some cases to remove NOx which may be formed in the thermal oxidation section. Suitable NOx treatment sections include, but are not limited to, selective catalytic reduction (SCR) or selective non-catalytic reduction (SNCR) to treat the acid gas stream fully.

In an SNCR unit, NOx forms N₂ and H₂O by mixing at high temperature with a nitrogen-containing component, such as NH₃ or urea. SNCR does not use a catalyst.

In an SCR unit, an ammonia and/or urea stream is introduced into the SCR section where it reacts with the NOx and forms N₂ and H₂O. Any suitable SCR catalyst could be used, including but not limited to, ceramic carrier materials such as titanium oxide with active catalytic components such as oxides of base metals including TiO₂, WO₃ and V₂O₅, or an activated carbon based catalyst.

The treated gas can be released to the atmosphere based on customer and/or local emission requirements.

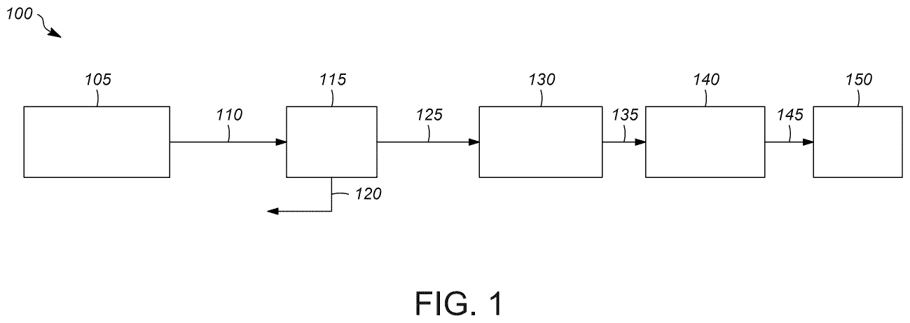

FIG. 1 illustrates one embodiment of the process 100 for treating an acid gas stream in a process for producing renewable transportation fuel. The renewable transportation fuel process unit 105 produces a sour water stream 110, along with other streams which are not shown.

The sour water stream 110 is sent to a sour water stripper 115 where it is separated into a stripped sour water stream 120 and an acid gas stream 125. The stripped sour water stream 120 can be sent to a waste water treatment unit (not shown).

The acid gas stream 125 is sent to a sulfur treatment zone 130 for removing H₂S. The H₂S can be removed using adsorption processes, amine processes, scrubbing processes, or neutralization processes. The second acid gas stream 135 from the sulfur treatment zone 130 has a lower level of H₂S than the incoming acid gas stream 125.

The second acid gas stream 135 is sent to the thermal oxidation section 140 where it is incinerated.

The treated outlet stream 145 is vented to the atmosphere through a vent stack 150.

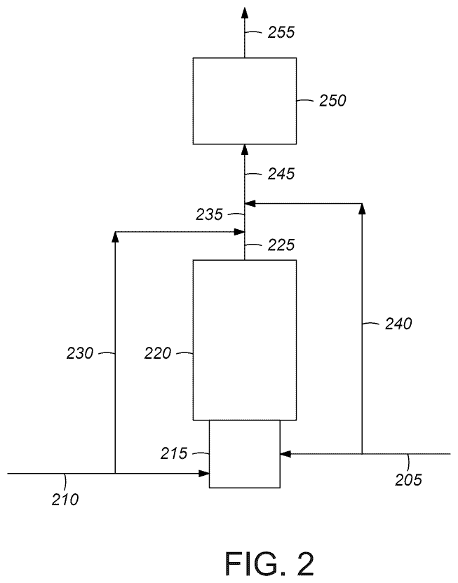

FIG. 2 illustrates one embodiment of a thermal oxidizing section and a NOx treatment section in a process where H₂S has been removed from the acid gas stream.

The second acid gas stream 205 and an ambient air stream 210 are sent to the burner 215 of the thermal oxidizer 220 where the acid gas stream is thermally oxidized.

The thermal oxidizer effluent stream 225 from the thermal oxidizer 220 is combined with a slip stream 230 of ambient air stream 210 to cool the thermal oxidizer effluent stream 225 forming a cooled effluent stream 235.

A slip stream 240 of the acid gas stream 205 is combined with the cooled effluent stream 235 forming a combined effluent stream 245.

The combined effluent stream 245 is sent to the SCR unit 250 where the NOx is converted to N₂ and water.

The treated outlet stream 255 can be released to the atmosphere.

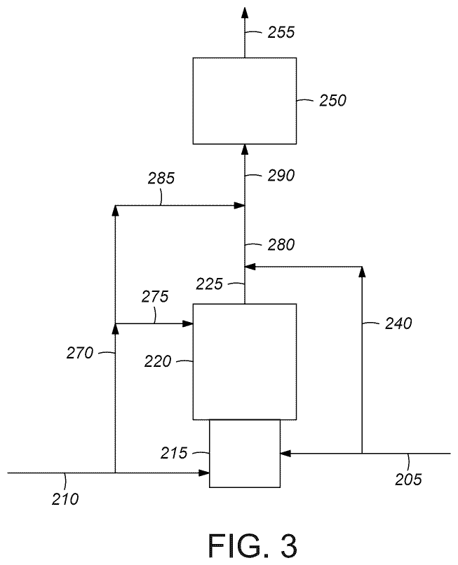

FIG. 3 is an illustration of another embodiment of a thermal oxidizing section and a NOx treatment section in a process where H₂S has not been removed from the acid gas stream.

The second acid gas stream 205 and an ambient air stream 210 are sent to the burner 215 of the thermal oxidizer 220 where the acid gas stream is thermally oxidized.

A slip stream 270 is removed from ambient air stream 210. A portion 275 of the ambient air slip stream 270 is used to cool the thermal oxidizer 220.

A slip stream 240 of the acid gas stream 205 is combined with the thermal oxidizer effluent stream 225 forming a combined effluent stream 280.

A second portion 285 of the ambient air slip stream 270 is combined with the combined effluent stream 280 forming a cooled combined effluent stream 290.

The cooled combined effluent stream 290 is sent to the SCR unit 250 where the NOx is converted to N₂ and water.

The treated outlet stream 255 can be released to the atmosphere.

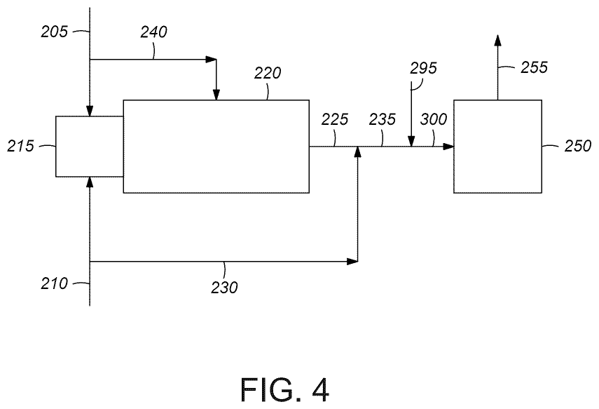

FIG. 4 is an illustration of another embodiment of a thermal oxidizing section and a NOx treatment section in a process where H₂S has been removed from the acid gas stream.

The second acid gas stream 205 and an ambient air stream 210 are sent to the burner 215 of the thermal oxidizer 220 where the acid gas stream is thermally oxidized.

A slip stream 240 of the acid gas stream 205 is introduced into the thermal oxidizer 220.

The thermal oxidizer effluent stream 225 from the thermal oxidizer 220 is combined with a slip stream 230 of ambient air stream 210 to cool the thermal oxidizer effluent stream 225 forming a cooled effluent stream 235.

A nitrogen containing stream 295 is combined with the cooled effluent stream 235 forming a nitrogen containing effluent stream 300 so the nitrogen containing component is available to react with NOx in the SCR 250.

The nitrogen containing effluent stream 300 is sent to the SCR unit 250 where the NOx is converted to N₂ and water.

The treated outlet stream 255 can be released to the atmosphere.

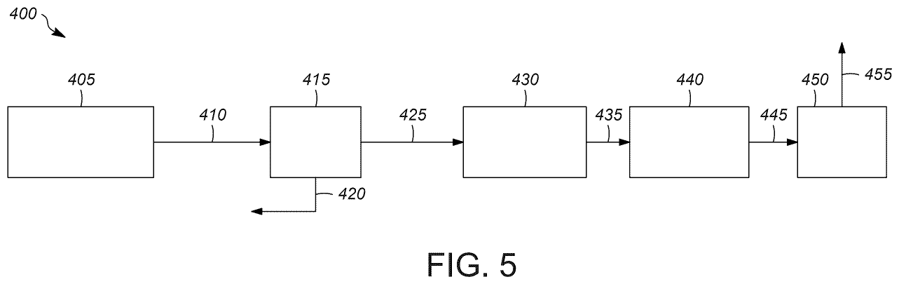

FIG. 5 illustrates another embodiment of the embodiment of the process 400 for treating an acid gas stream in a process for producing renewable transportation fuel.

The renewable transportation fuel process unit 405 produces a sour water stream 410, along with other streams which are not shown.

The sour water stream 410 is sent to a sour water stripper 415 where it is separated into a stripped sour water stream 420 and an acid gas stream 425. The stripped sour water stream 420 can be sent to a waste water treatment unit (not shown).

The acid gas stream 425 is sent to a thermal oxidation section 430 where it is incinerated to form a thermally oxidized gas stream 435.

The thermally oxidized gas stream 435 is sent to a SOx removal section 440 for removing H₂S. The H₂S can be removed using any suitable process for removing H₂S. Suitable processes include, but are not limited to, adsorption processes, amine processes, scrubbing processes, or neutralization processes. Suitable processes include. But are not limited to contacting the thermally oxidized gas stream with a caustic solution or an NH₃ based solution in a scrubbing section or reacting the flue gas stream with a reactant comprising at least one of NaHCO₃, NaHCO₃Na₂CO₃·2(H₂O), CaCO₃, Ca(OH)₂, and Mg(OH)₂.

The SOx treated stream 435 has a lower level of H₂S than the incoming thermally oxidized gas stream 435.

The SOx treated stream 435 is sent to NOx removal section 440 NOx is removed. Any suitable NOx removal section can be used. Suitable NOx removal sections include, but are not limited to, selective catalytic reduction units or a selective non-catalytic reduction units.

The NOx treated outlet stream 455 has a lower level of NOx than the incoming SOx treated stream 445.

The NOx treated outlet stream 455 may be vented to the atmosphere.

### EXAMPLES

The acid gas stream (before adsorbent) contained 2390 wppm of H₂S.

If the acid gas stream was sent directly to a thermal oxidizer system, SOx scrubbing would be needed. This could be accomplished in two ways: wet SO₂ scrubbing using caustic solution in a packed bed scrubber, or dry SO₂ and SO₃ scrubbing using sodium bicarbonate.

For the wet SO2 scrubbing, the reactions are:

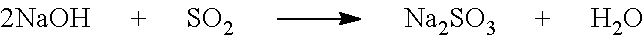

The flue gas is brought to saturation by cooling, and the reaction happens in an aqueous phase to bring the SO₂ to below the desired emission target.

For the dry SO₂ and SO₃ scrubbing, the flue gas is partially cooled, then sent to a dry scrubbing reactor where sodium bicarbonate powder is injected After the following reactions, the sodium sulfate powder is removed using particulate removal technology.

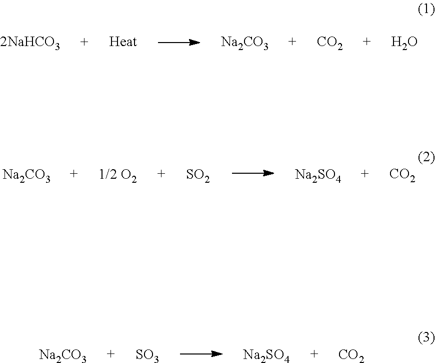

Removing the H₂S in the adsorber means that when the acid gas is incinerated, minimal SOx is produced, so the SOx scrubbing step is not needed, as shown below.

The simulation (as well as process development) has shown that the H₂S in the acid gas can be reduced to less than 1 wppm using an adsorber, and to less than 50 mppm (mole ppm) using an amine process.

| | | |
|---|---|---|
| H₂S in acid gas before adsorbent | 2400 | wppm |
| H₂S in acid gas after adsorbent (135) | <1 | wppm |
| in proposed scheme caustic solution consumption | 0 | |

### SPECIFIC EMBODIMENTS

While the following is described in conjunction with specific embodiments, it will be understood that this description is intended to illustrate and not limit the scope of the preceding description and the appended claims.

A first embodiment of the invention is a process for treating an acid gas stream in a process for producing renewable transportation fuel comprising removing H₂S from the acid gas stream to form a second acid gas stream having a level of H2S lower than a level of H2S in the acid gas stream, wherein the H2S is removed using an adsorption process, an amine process, a scrubbing process, or a neutralization process; thermally oxidizing the second acid gas stream from the process for producing renewable transportation fuel in a thermal oxidation section comprising a thermal oxidizer to form a thermally oxidized stream; removing NOx from the thermally oxidized stream to form a treated outlet stream; and venting the treated outlet stream to the atmosphere. An embodiment of the invention is one, any or all of prior embodiments in this paragraph up through the first embodiment in this paragraph further comprising stripping a sour water stream from the process for producing renewable transportation fuel in a sour water stripper into a stripped sour water stream and the acid gas stream. An embodiment of the invention is one, any or all of prior embodiments in this paragraph up through the first embodiment in this paragraph wherein the sour water stream comes from a cold separation and fractionation section in the process for producing renewable transportation fuel. An embodiment of the invention is one, any or all of prior embodiments in this paragraph up through the first embodiment in this paragraph wherein the H₂S is removed using the adsorption process. An embodiment of the invention is one, any or all of prior embodiments in this paragraph up through the first embodiment in this paragraph wherein the adsorption process comprises an iron sponge adsorption process. An embodiment of the invention is one, any or all of prior embodiments in this paragraph up through the first embodiment in this paragraph wherein the H₂S is removed using the H₂S is removed using the amine process. An embodiment of the invention is one, any or all of prior embodiments in this paragraph up through the first embodiment in this paragraph wherein the H₂S is removed using the scrubbing process. An embodiment of the invention is one, any or all of prior embodiments in this paragraph up through the first embodiment in this paragraph wherein the H₂S is removed using the neutralization process. An embodiment of the invention is one, any or all of prior embodiments in this paragraph up through the first embodiment in this paragraph wherein removing NOx from the thermally oxidized stream comprises removing NOx in a selective catalytic reduction unit, or a selective non-catalytic reduction unit, or both. An embodiment of the invention is one, any or all of prior embodiments in this paragraph up through the first embodiment in this paragraph wherein the thermal oxidation section comprises the thermal oxidizer and a burner, and wherein thermally oxidizing the second acid gas stream comprises combusting the second acid gas stream in the burner and passing the combustion gases though the thermal oxidizer forming a thermal oxidizer effluent stream; combining a slip stream of the second acid gas stream with the thermal oxidizer effluent stream forming a combined thermal oxidizer effluent stream; passing the combined thermal oxidizer effluent stream to a selective catalytic reduction unit or a selective non-catalytic reduction unit to form the treated outlet stream. An embodiment of the invention is one, any or all of prior embodiments in this paragraph up through the first embodiment in this paragraph further comprising cooling the thermal oxidizer effluent stream. An embodiment of the invention is one, any or all of prior embodiments in this paragraph up through the first embodiment in this paragraph wherein the outlet end of the thermal oxidizer is cooled with air. An embodiment of the invention is one, any or all of prior embodiments in this paragraph up through the first embodiment in this paragraph further comprising introducing air into the thermal oxidizer effluent stream, or the combined thermal oxidizer effluent stream, or both before passing the combined thermal oxidizer effluent stream to the selective catalytic reduction unit or the selective non-catalytic reduction unit. An embodiment of the invention is one, any or all of prior embodiments in this paragraph up through the first embodiment in this paragraph wherein the thermal oxidizer section comprises the thermal oxidizer and a burner, and wherein thermally oxidizing the second acid gas stream comprises combusting the second acid gas stream in the burner and passing the combustion gases though the thermal oxidizer forming a thermal oxidizer effluent stream; introducing a slip stream of the second acid gas stream into the thermal oxidizer; combining a nitrogen-containing stream with the thermal oxidizer effluent stream forming a nitrogen-containing thermal oxidizer effluent stream; passing the nitrogen-containing thermal oxidizer effluent stream to a selective catalytic reduction unit, or a selective non-catalytic unit to form the treated outlet stream. An embodiment of the invention is one, any or all of prior embodiments in this paragraph up through the first embodiment in this paragraph further comprising introducing air into the thermal oxidizer effluent stream, or the nitrogen-containing thermal oxidizer effluent stream, or both before passing the combined thermal oxidizer effluent stream to the selective catalytic reduction unit or the selective non-catalytic reduction unit. An embodiment of the invention is one, any or all of prior embodiments in this paragraph up through the first embodiment in this paragraph wherein the nitrogen-containing stream comprises ammonia, or urea, or both.

A second embodiment of the invention is a process for treating an acid gas stream in a process for producing renewable transportation fuel comprising thermally oxidizing the acid gas stream from the process for producing renewable transportation fuel in a thermal oxidation section comprising a thermal oxidizer to form a thermally oxidized gas stream; removing H₂S from the thermally oxidized gas stream to form a SOx treated gas stream having a level of H₂S lower than a level of H₂S in the acid gas stream; removing NOx from the SOx treated stream to form a NOx treated outlet stream having a level of NOx lower than a level of NOx in the SOx treated stream; and venting the NOx treated outlet stream to the atmosphere. An embodiment of the invention is one, any or all of prior embodiments in this paragraph up through the second embodiment in this paragraph wherein removing H₂S from the thermally oxidized gas stream comprises removing H₂S by contacting the thermally oxidized gas stream with a caustic solution or an NH₃ based solution in a scrubbing section or reacting the flue gas stream with a reactant comprising at least one of NaHCO₃, NaHCO₃Na₂CO₃·2(H₂O), CaCO₃, Ca(OH)₂, and Mg(OH)₂. An embodiment of the invention is one, any or all of prior embodiments in this paragraph up through the second embodiment in this paragraph wherein removing NOx from the SOx treated stream comprises removing NOx in a selective catalytic reduction unit or a selective non-catalytic reduction unit. An embodiment of the invention is one, any or all of prior embodiments in this paragraph up through the second embodiment in this paragraph further comprising recovering waste heat from the thermally oxidized gas stream in a waste heat recovery section.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for treating an acid gas stream in a process for producing renewable transportation fuel comprising:
removing H₂S from the acid gas stream to form a second acid gas stream having a level of H₂S lower than a level of H₂S in the acid gas stream, wherein the H₂S is removed using an adsorption process, an amine process, a scrubbing process, or a neutralization process;
thermally oxidizing the second acid gas stream from the process for producing renewable transportation fuel in a thermal oxidation section comprising a thermal oxidizer to form a thermally oxidized stream;
removing NOx from the thermally oxidized stream to form a treated outlet stream; and
venting the treated outlet stream to the atmosphere.

2. The process of claim 1 further comprising:
stripping a sour water stream from the process for producing renewable transportation fuel in a sour water stripper into a stripped sour water stream and the acid gas stream.

3. The process of claim 1 wherein the sour water stream comes from a cold separation and fractionation section in the process for producing renewable transportation fuel.

4. The process of claim 1 wherein the H₂S is removed using the adsorption process.

5. The process of claim 4 wherein the adsorption process comprises an iron sponge adsorption process.

6. The process of claim 1 wherein the H₂S is removed using the H₂S is removed using the amine process.

7. The process of claim 1 wherein the H₂S is removed using the scrubbing process.

8. The process of claim 1 wherein the H₂S is removed using the neutralization process.

9. The process of claim 1 wherein removing NOx from the thermally oxidized stream comprises removing NOx in a selective catalytic reduction unit, or a selective non-catalytic reduction unit, or both.

10. The process of claim 1 wherein the thermal oxidation section comprises the thermal oxidizer and a burner, and wherein thermally oxidizing the second acid gas stream comprises:
combusting the second acid gas stream in the burner and passing the combustion gases though the thermal oxidizer forming a thermal oxidizer effluent stream;
combining a slip stream of the second acid gas stream with the thermal oxidizer effluent stream forming a combined thermal oxidizer effluent stream;
passing the combined thermal oxidizer effluent stream to a selective catalytic reduction unit or a selective non-catalytic reduction unit to form the treated outlet stream.

11. The process of claim 10 further comprising:
cooling the thermal oxidizer effluent stream.

12. The process of claim 11 wherein the outlet end of the thermal oxidizer is cooled with air.

13. The process of claim 10 further comprising:
introducing air into the thermal oxidizer effluent stream, or the combined thermal oxidizer effluent stream, or both before passing the combined thermal oxidizer effluent stream to the selective catalytic reduction unit or the selective non-catalytic reduction unit.

14. The process of claim 1 wherein the thermal oxidizer section comprises the thermal oxidizer and a burner, and wherein thermally oxidizing the second acid gas stream comprises:
combusting the second acid gas stream in the burner and passing the combustion gases though the thermal oxidizer forming a thermal oxidizer effluent stream;
introducing a slip stream of the second acid gas stream into the thermal oxidizer;
combining a nitrogen-containing stream with the thermal oxidizer effluent stream forming a nitrogen-containing thermal oxidizer effluent stream;
passing the nitrogen-containing thermal oxidizer effluent stream to a selective catalytic reduction unit, or a selective non-catalytic unit to form the treated outlet stream.

15. The process of claim 14 further comprising:
introducing air into the thermal oxidizer effluent stream, or the nitrogen-containing thermal oxidizer effluent stream, or both before passing the combined thermal oxidizer effluent stream to the selective catalytic reduction unit or the selective non-catalytic reduction unit.

16. The process of claim 14 wherein the nitrogen-containing stream comprises ammonia, or urea, or both.

17. A process for treating an acid gas stream in a process for producing renewable transportation fuel comprising:
thermally oxidizing the acid gas stream from the process for producing renewable transportation fuel in a thermal oxidation section comprising a thermal oxidizer to form a thermally oxidized gas stream;
removing H₂S from the thermally oxidized gas stream to form a SOx treated gas stream having a level of H₂S lower than a level of H₂S in the acid gas stream;
removing NOx from the SOx treated stream to form a NOx treated outlet stream having a level of NOx lower than a level of NOx in the SOx treated stream; and
venting the NOx treated outlet stream to the atmosphere.

18. The process of claim 17 wherein removing H₂S from the thermally oxidized gas stream comprises removing H₂S by contacting the thermally oxidized gas stream with a caustic solution or an NH₃ based solution in a scrubbing section or reacting the flue gas stream with a reactant comprising at least one of NaHCO₃, NaHCO₃—Na₂CO₃·2(H₂O), CaCO₃, Ca(OH)₂, and Mg(OH)₂.

19. The process of claim 17 wherein removing NOx from the SOx treated stream comprises removing NOx in a selective catalytic reduction unit or a selective non-catalytic reduction unit.

20. The process of claim 17 further comprising:
recovering waste heat from the thermally oxidized gas stream in a waste heat recovery section.
